(19) United States
(12) Patent Application Publication
(10) Pub. No.: US 2015/0207360 A1
(43) Pub. Date: Jul. 23, 2015

(54) INTEGRATED MOBILE PHONE CASE AND CHARGER

(71) Applicants: Michael Adams, Decatur, AL (US); Renee Adams, Decatur, AL (US)

(72) Inventors: Michael Adams, Decatur, AL (US); Renee Adams, Decatur, AL (US)

(21) Appl. No.: 14/161,647

(22) Filed: Jan. 22, 2014

(51) Int. Cl. H02J 7/35; H02J 7/00

(52) U.S. Cl. CPC H02J 7/35; H02J 7/0042; H04B 1/3883

(57) ABSTRACT

An integrated mobile phone case and charger for providing both a protective casing for a mobile device which includes an integrated solar cell for charging the battery of the mobile device therein. The integrated mobile phone case and charger comprises a case body defined by a front piece and a back piece, with the back piece including solar cells, electrical wiring, and a charging port. The front piece and back piece are configured to releasable attached to each other to form an enclosure in which a mobile phone or other mobile device is placed and secured. The solar cells electricity to be generated to be supplied to the battery of a mobile device disposed in the integrated mobile phone case and charger. Electricity generated carried through electrical wires mounted on the inside surface of the back piece to a charging port, where it is provided to the mobile device.

### BACKGROUND OF THE INVENTION

1. Field of the Invention

This invention relates generally to mobile phone accessories and, more particularly, to a protective case for a mobile phone which includes an integrated solar cell for charging the mobile phone battery.

2. Description of the Prior Art

The use of mobile communication devices (or mobile devices), such as PDAs, cell phones (or smart phones, or mobile phones), and tablet computers, is well known. It is understood that such devices must be supplied with electricity to power their operations. Consequently, rechargeable batteries are typically utilized to enable the provisions of electrical power while not substantially compromising the mobile aspect of such mobile devices.

A problem which still exists, however, is that the use of rechargeable batteries inherently requires the battery be recharged in order for it to continue to supply the mobile device with electrical power. Recharging is typically accomplished through the use of battery chargers which plug into a port on the mobile device and to an electrical outlet to facility the transfer of electrical power from the electrical outlet for storage in the battery. When a mobile device is plugged in to a battery charger which is plugged into a wall electrical outlet, however, it essentially becomes tethered to the wall and its mobile aspect is lost for the duration of time the battery is recharged. Thus, there remains a need for an integrated mobile phone case and charger which enables the battery of a mobile device to be recharged without being connected to a wall electrical outlet or otherwise tethering the mobile device to a fixed location. It would be helpful if such an integrated mobile phone case and charger was embodied as a case adapted to additionally provide protection for the mobile device from physical damage. It would be additionally desirable for such an integrated mobile phone case and charger to utilized solar cells which converted light to electricity to be used to recharge the battery on the mobile device.

The Applicant's invention described herein provides for a mobile phone case and charger adapted to harvest ambient or supplied light energy and supply electricity therefrom to a mobile device. The primary components of Applicant's integrated mobile phone case and charger include a hard rubber mobile phone case having a built in solar cell. When in operation, the integrated mobile phone case and charger allows a mobile device on which it is disposed to become self sustaining through ongoing conversion of light to electricity to be provided to the battery. As a result, many of the limitations imposed by the mobile device battery charging systems are removed.

### SUMMARY OF THE INVENTION

An integrated mobile phone case and charger for providing both a protective casing for a mobile device which includes an integrated solar cell for charging the battery of the mobile device therein. The integrated mobile phone case and charger comprises a case body, providing a cover means for encasing a mobile device, which includes solar cells, electrical wiring, and a charging port. The case body is defined by a front piece and a back piece, which are configured to be releasable attached through the operation of a plurality of fasteners to each other to form an enclosure in which a mobile phone or other mobile device is placed and secured. The solar cells enable the integrated mobile phone case and charger to generate its own electrical energy to be supplied to the battery of a mobile device disposed in the integrated mobile phone case and charger. In this regard, the solar cells provide a cell means for converting light into electricity. Electricity generated by the solar cells is carried through electrical wires mounted on the inside surface of the back piece to a charging port, where it is provided to the mobile device. Thus, the charging port provides a port means for providing electricity to an encased mobile device and the electrical wires provide a means for directing electricity from the cell means to the port means. The charging port and the electrical wires are mounted on the inside surface of the back piece. Thus, other than the solar cells on the exterior of the back piece, exterior of the integrated mobile phone case and charger is substantially indistinguishable from many protective cases in the prior art.

It is an object of this invention to provide an integrated mobile phone case and charger which enables the battery of a mobile device to be recharged without being connected to a wall electrical outlet or otherwise tethering the mobile device to a fixed location.

It is another object of this invention to provide an integrated mobile phone case and charger embodied as a case adapted to additionally provide protection for the mobile device from physical damage.

It is yet another object of this invention to provide an integrated mobile phone case and charger to utilized solar cells which converted light to electricity to be used to recharge the battery on the mobile device.

These and other objects will be apparent to one of skill in the art.

### BRIEF DESCRIPTION OF THE DRAWINGS

FIG. 1a is a rear perspective view of an integrated mobile phone case and charger built in accordance with the present invention.

FIG. 1b is a front elevational view of an integrated mobile phone case and charger built in accordance with the present invention.

FIG. 1c is a side elevational view of an integrated mobile phone case and charger built in accordance with the present invention

FIG. 2 is a back perspective view of the back piece of an integrated mobile phone case and charger built in accordance with the present invention with electrical wiring and a phone port in shadow.

FIG. 3 is a front elevational view of the back piece of an integrated mobile phone case and charger built in accordance with the present invention.

### DETAILED DESCRIPTION OF THE INVENTION

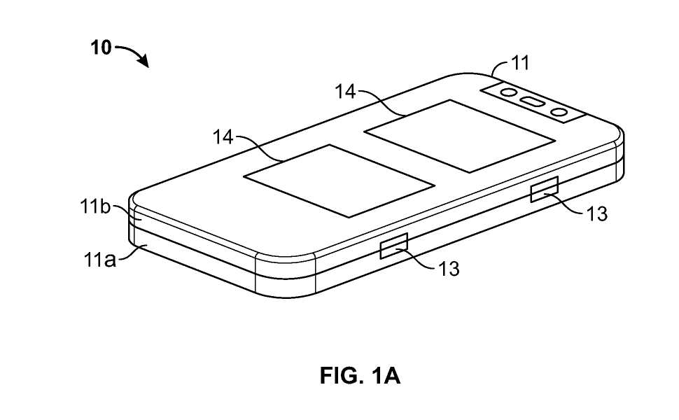

Referring now to the drawings and in particular FIGS. 1a, 1b, and 1c, an integrated mobile phone case and charger 10 is shown having a case body 11 defined by a hard, canvassed rubber body having a front piece 11a and a back piece 11b. The front piece 11a and back piece 11b are configured to releasable attached to each other to form an enclosure in which a mobile phone 12 or other mobile device is placed and secured. The front piece 11a and the back piece are releasably attached to each other through the operation of a plurality of fasteners 13, defined in the preferred embodiment as a latch fastener having corresponding fastening portions on the front piece 11a and the back piece 11b. In this regard, the case body 11 is structured to be secured over a mobile device in a manner substantially similar to mobile device cases in the prior art.

The back piece 11b of the case body 11 additionally includes two solar cells 14 which are adapted to covert light energy into electrical energy. These solar cells 14 enable the integrated mobile phone case and charger 10 to generate its own electrical energy to be supplied to the battery of a mobile device disposed therein. While two solar cells 14 disposed on the back piece 11b are utilized in the preferred embodiment, it is contemplated that the integrated mobile phone case and charger 10 may alternatively operate with one solar cell 14 or three or more solar cells 14 disposed thereon.

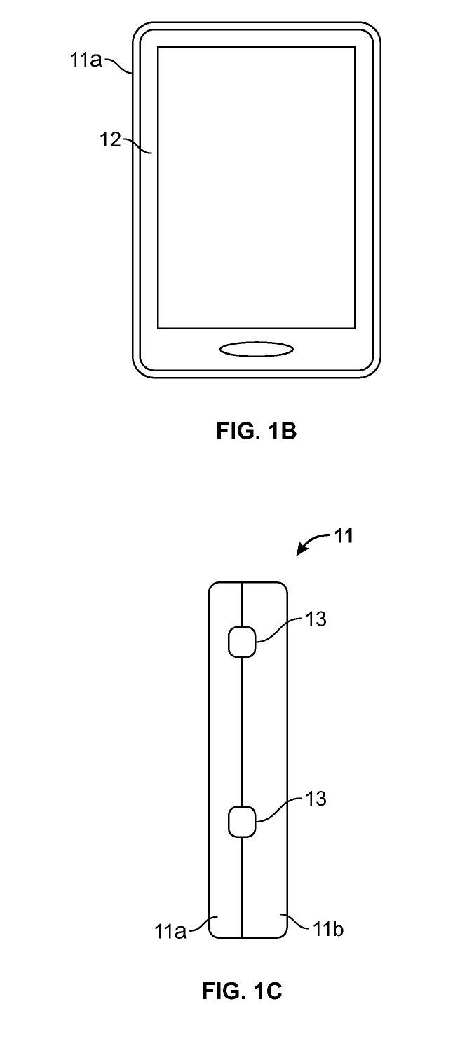

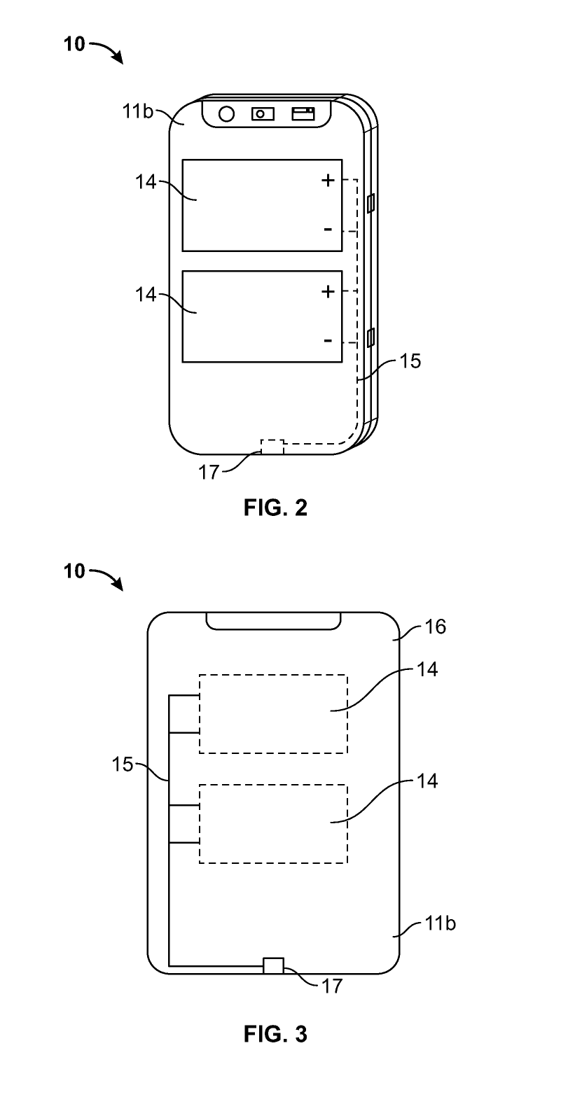

Referring now to FIGS. 2 and 3, electricity generated by the solar cells 14 of the integrated mobile phone case and charger 10 and provided to a mobile device secured therein is carried through electrical wires 15 mounted on the inside surface 16 of the back piece 11b to a charging port 17. The inside surface 16 of the back piece 11 is the surface which contacts a mobile device mounted in the integrated mobile phone case and charger 10. In this regard, the electrical wires are not visible or accessible when the integrated mobile phone case and charger 10 is on a mobile device.

The charging port 17 is embodied as a conventional port through which the mobile device is configured to receive electrical power from a conventional battery charger. The charging port 17 is fixedly mounted on the inside surface 16. It is contemplated that as mobile devices are of many types of shapes and sizes, and are constructed with the outlets for a port through which electrical power is received in a variety of locations, the dimensions of the case body and the location of the charging port 17 of an integrated mobile phone case and charger 10 will differ for different models. But it is further contemplated that for mobile devices having a charging outlet at the bottom of the device, the charging port 17 for the integrated mobile phone case and charger 10 configured therefor will be disposed on the bottom of the inside surface 16.

It is contemplated that the solar cells 14 built in accordance with the present invention can be adapted to convert natural light and/or artificial light to electricity.

In an alternate embodiment, the charging port 17 will be configured to swivel slightly to lessen pressure placed on the charging port 17 and the charging outlet of a mobile device when the back piece 11b is installed or removed from the mobile phone.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. An integrated mobile phone case and charger, comprising:
a case body is configured to be secured on a mobile device;
at least one solar cell disposed on said case body;
electrical wiring connected to each at least one solar cell; and
a charging port disposed on said case body, wherein said electrical wiring is connected to said charging port and directs electricity generated by each at least one solar cell to said charging port, enabling said charging port to provide electricity to a device connected thereto.

2. The integrated mobile phone case and charger of claim 1, wherein said case body includes a front piece and a back piece configured to releasably attach to each other.

3. The integrated mobile phone case and charger of claim 2, wherein said at least one solar cell, said electrical wiring, and said charging port are disposed on said back piece.

4. The integrated mobile phone case and charger of claim 3, wherein:
said back piece includes an inside surface which is configured to contact a mobile device disposed in said case body;
said at least one solar cell is disposed on the side of the back piece opposite the inside surface; and
said electrical wiring and said charging port are disposed on said inside surface.

5. The integrated mobile phone case and charger of claim 1, wherein two solar cells are disposed on said case body.

6. An integrated mobile phone case and charger, comprising:
a cover means for encasing a mobile device;
a cell means for converting light into electricity;
a port means for providing electricity to an encased mobile device; and
a means for directing electricity from the cell means to the port means.
